(19) United States
(12) Patent Application Publication
(10) Pub. No.: US 2003/0153663 A1
(43) Pub. Date: Aug. 14, 2003

(54) Alkoxylated alcohols as plasticizers for polyvinylacetate plastics

(76) Inventor: Dirk Schar, Meldorf (DE)

Correspondence Address: C James Bushman, Browning Bushman, Suite 1800, 5718 Westheimer, Houston, TX, 77057-5771, US

(21) Appl. No.: 10/220,094

(22) PCT Filed: Dec. 19, 2001
(86) PCT No.: PCT/DE01/04805

(30) Foreign Application Priority Data
Dec. 27, 2000 (DE) 100 65 058.9

(51) Int. Cl. C08K 5/05

(52) U.S. Cl. 524/379; 524/557

(57) ABSTRACT

This invention relates to compositions containing polyvinyl acetate plastics and alkoxylated alcohols as plasticisers.

This invention relates to a composition containing polyvinyl acetate (PVAc) plastics and alkoxylated alcohols.

Short-chain dialkyl phthalates have been known for a long time gas plasticisers for polyvinyl acetate polymers. Among others, dibutyl phthalate (DBP) and di-iso-butyl phthalate (DiBP) have gained commercial importance. These substances are well compatible with polyvinyl acetate and have the conveniently low viscosities (cf. for example: Wilson, A. S., Plasticisers, Institute of Materials, 1995, p. 206-212).

U.S. Pat. No. 4,076,678 discloses the use of polyesters as plasticisers in polyvinyl acetate plastics. The polyester is obtainable by reaction of three components, namely a dibasic C₄- to C₁₀-acid or its anhydride, an aliphatic C₂- to C₁₁-alcohol, and a polyalkylene glycol. The PVAc plastics plasticised in this way are employed among others for surface coatings, adhesives, and binders. They are superior to PVAc polymers compounded with DBP in that there is an improvement in the solvent extraction resistance and the volatile loss of the plasticiser is reduced.

U.S. Pat. Nos. 4,379,190 and 4,438,228 disclose sound-deadening sheetings containing copolymers of ethylene (among others vinyl acetate as a comonomer (EVA polymers) as well), plasticisers, and filler. Examples of plasticisers given therein are ethylene oxide- and/or polypropylene oxide polymers which may bear one or two ester end group(s) besides many other appropriate plasticisers.

EP 0 882 765-A2 discloses thermoplastic biodegradable compositions. The starch-polymer blends described therein comprise starch, a vinyl acetate copolymer, and a plasticiser. Examples of suitable plasticisers include ethoxylated glycols and polyethylene glycol.

Furthermore, numerous compounds which are useful as plasticisers for PVAc plastics/blends are known from technical literature, for example adipates, such as di-butyl adipate, benzoates, such as dipropyleneglycol benzoate, glycol esters, such as triethyleneglycol di-2-ethylbutyrate, glycerides, such as triacetin, citrates, such as acetyl tributyl citrate, and phosphates, such as tri-2-ethylhexylphosphate (see Sears, J. K., Darbyl, J. R.; The Technology of Plasticizers; Wiley New York, 1982, p. 966-975).

Although the abovementioned plasticisers commonly have a fairly good plasticising effect in PVAc plastics, they frequently are highly volatile or, where their volatility is sufficiently low, have the disadvantage of resulting in brittle rigid plastics on further processing.

It is, therefore, an object of this invention to avoid the disadvantages of the prior art described hereinabove and to provide plasticisers for PVAc plastics, which are highly compatible with PVAc and concurrently result in both high tensile strength of the plastic material and low fogging of the plasticiser.

According to the present invention, there is provided a composition comprising

(a) a polyvinyl acetate homo- or mixed polymerisate as a polyvinyl acetate plastic and

(b) from 0.01 to 50 weight percent, preferably 1 to 40 weight percent, most preferably 3 to 30 weight percent, referring to the total of components (a) and (b), of a mixture of several ‘narrow-range’ alkoxylated alcohols according to the formula I

R¹[—O—(R²—O)ₙ—H]ₘ I

with at least n being different,

where

R¹ is a C₄- to C₁₄-hydrocarbon, particularly a saturated C₅- to C₁₀-hydrocarbon which can have 1 or 2 free OH groups,

R² is a saturated divalent C₂- to C₄-hydrocarbon which can be different for each a and/or m,

n is an integer from 4 to 18, preferably 7 to 16, most preferably 7 to 14, where n can be different for each m, and

m is an integer from 1 to 4, preferably 1 to 2, particularly 1.

As used herein, the term ‘narrow-range’ alkoxylates is defines as alkoxylates where at least 60 percent, preferably at least 70 percent of the alkoxylated alcohols according to formula I in the composition have for each n of a molecule one n of from +2 to −2 of the number average of the alkoxylation degrees n of the alkoxylated alcohols according to formula I comprised in the composition.

An alkoxylate having two or more alkoxylate groups with one n already not fulfilling the aforesaid condition, i.e. from +2 to −2 of the number average m, this alkoxylate does not belong to the group of alkoxylates with n ranging from +2 to −2 of the number average of the alkoxylation degrees n.

As used herein, narrow-range alkoxylates are defined as mixtures of at least 2, preferably at least 3 alkoxylates having different degrees of alkoxylation n of the alkoxy groups.

Preferably, not more than 90 percent of the alkoxylated alcohols according to formula I in the composition have one n ranging from +2 to −2 of the number average of the alkoxylation degrees n of the alkoxylated alcohols comprised in the composition.

The plasticiser is preferably employed in compositions of solids. The term ‘compositions of solids’ as used herein shall mean compositions having a pour point of greater than 25° C., preferably greater than 50° C., at normal pressure (1013 hPa).

Further advantageous embodiments of the present invention are set out in the subordinate claims.

R¹ can be a linear or branched hydrocarbon. Preferably, it can also be a saturated hydrocarbon. Example of branched alcohols include alcohols which are alkyl-branched in 2-position, such as Guerbet alcohols.

R¹ can be a monoalcohol or a polyol with as many as 6 OH groups of which optionally one or two nonalkoxylated ones may remain after the alkoxylation. Preferably, m is equal to 1 or 2 and R¹ has no free OH groups any more.

R² represents the alkylene unit of the alkoxylate and is a saturated divalent C₂- to C₄-hydrocarbon which can be different for each n and/or m and need not necessarily be a 1,2-linked alkylene. In the production, especially ethylene oxide (EO) and/or propylene oxide (PO), alone or in blends, are employed as alkoxylation agents.

The alkoxylated alcohols of the present invention can be mixtures of different homologues having a different number of alkylene oxide units, depending on the degree of alkoxylation, wherein n is an integer from 4 to 18, preferably 7 to 14.

It is the object of the present invention to provide narrow-range alkoxylates. Such products are exceptionally compatible with PVAc plastics and present low fogging values, i.e. have reduced volatilities. At the same time, they exhibit excellent plasticising properties and have the desired high tensile strengths. Standard alkoxylates having a wide distribution of homologues, including high EO-/PO homologues and the low ones, are less compatible with PVAc.

The PVAc plastic comprised in the composition can be employed both as a homopolymer and a copolymer. Suitable comonomers include for example ethylene, styrene, or acrylic acid/acrylate. It is preferred that the PVAc plastic contains more than 50 percent vinyl acetate monomers, mast preferably more than 80 percent, based on the number average of the polymerisation degree.

The average molecular masses of the polyvinyl acetates can be adjusted as required for the respective uses. For example, they may range from 30,000 to 40,000 g/mole with low-molecular PVAc plastics, may be around 60,000 g/mole with average-molecular ones, and may be greater than 100,000 g/mole with high-molecular PVAc plastics. The plasticisers of the invention are especially suitable for use in PVAC polymers having molecular masses of greater than 100,000 g/mole, which are used among others as sheeting commonly having molecular weights of from 100,000 g/mole to 150,000 g/mole. All the molecular masses stated hereinabove are average weights.

### Experiments

Method of Determining the Critical Solution Temperature (CST)

In order to determine the gelation properties of a possibly suitable plasticiser, it has proved to be advantageous to determine the critical solution temperature according to DIN 53 408:

5 grams of polymer were suspended in 95 grams of plasticiser at room temperature. The temperature was slowly increased (approx. 1° C./min.). The CST is the temperature where the suspension becomes clear.

Gravimetric Determination of Fogging

Fogging was gravimetrically determined in accordance with DIN 75 201 Part B:

Into each test beaker, there were placed 10 grams of test liquid. After a fogging time of 16 hours at 100° C., the fog on the aluminium foils was determined gravimetrically.

Preparation of PVAc Sheets

The components were stirred to form a homogeneous powder (dry blend) which then was kneaded for 10 minutes at 160° C. and 30 rpm using a Brabender Plasti Corder kneader. The hot polymer mass was discharged from the kneader pot and pressed to form a sheet (0.5 mm thick) using a moulding press (Polystat 200S) heated to 170° C. and a spacing frame. Moulding comprises three steps:

1^{st} step: 1 minute, 70 bar, 170° C.

2^{nd} step: 3 minutes, 200 bar, 170° C.

3^{rd} step: cooling from 170° C. to 100° C. at 200 bar

Polymer mass and spacing frame were placed between two aluminium foils (0.1 mm thick) on the moulding press heated to 170° C. Once the plastic sheet was cold, the aluminium foils were removed.

### EXAMPLES

### Examples 1 to 14

The solution temperatures of different plasticisers were determined according to the method described hereinabove. The results have been compiled in table 1.

TABLE 1
Determination of the Critical Solution Temperatures
of Different Compounds

| | | Solution | |
|---|---|---|---|
| | | Temperature | |
| No. | Compound | [° C.] | Appearance after 24 Hours |
| 1 | Dibutyl phthalate | 111 | homogeneous, compatible |
| 2 | Diisobutyl phthalate | 110 | homogeneous, compatible |
| 3 | Benzylbutyl phthalate | 130 | homogeneous, compatible |
| 4 | Tetraethyleneglycol | Immeasurable | PVAc lumps, incompatible |
| 5 | ISOFOL ® 12-N II-16 | 165 | homogeneous, compatible |
| | EO | | |
| 6 | Hexyl carbitol | 109 | hard settings, partially compatible |
| 7 | Hexanol-3 EO* | 109 | hard settings, partially compatible |
| 8 | Hexanol-7 EO* | 116 | flowable settings, partially compatible |
| 9 | Hexanol-10 EO* | 125 | flowable settings, partially compatible |
| 10 | Hexanol-1.5 PO-5 EO* | 116 | hard settings, partially compatible |
| 11 | Hexanol-N II-8 EO | 121 | homogeneous, compatible |
| 12 | Hexanol-N II-8.5 EO | 120 | homogeneous, compatible |
| 13 | Hexanol-N II-9.5 EO | 127 | homogeneous, compatible |
| 14 | Hexanol-N II-12 EO | 137 | homogeneous, compatible |

Legend:
N II = narrow-range ethoxylates;
* = KOH-catalysed;
ISOFOL ® (2-butyl-octan-1-ol) = product of SASOL Germany GmbH

### Examples 15 to 23

Fogging of different PVAc plasticisers was gravimetrically determined on test specimens of 10 grams each.

TABLE 2
Gravimetric Fogging of Different Plasticisers

| | | Fogging |
|---|---|---|
| No. | Plasticiser | [mg] |
| 15 | Hexanol-1.5 PO-5 EO* | 53 |
| 16 | Hexanol-N II-8 EO | 7.8 |
| 17 | Hexanol-N II-9.5 EO | 5.6 |
| 18 | Dietnyl phthalate | 153 |
| 19 | Dibutyl phthalate | 60 |
| 20 | Diisobutyl phthalate | 81 |
| 21 | Benzyloctyl phthalate | 5.8 |
| 22 | Benzyl(C₇-C₉-alkyl)phthalate | 6 |
| 23 | Benzylbutyl phthalate | 5.5 |

### Embodiments 24 to 28

Preparation of Heavily Filled PVAc Sheets

Sheet specimens were prepared using 19 grams of polyvinyl acetate (homopolymer, average molecular mass 120,000 g/mole), 7 grams of plasticiser, and 64 grams of chalk. The mechanical data were determined. Table 3 shows the maximum tensile strengths.

TABLE 3
Maximum Tensile Strengths of Differently Plasticised PVAc Sheets

| No. | Plasticiser | Fogging [mg] |
|---|---|---|
| 24 | Hexanol-1.5 PO-5 EO* | 0.87 |
| 25 | Hexanol-N II-8 EO | 0.68 |
| 26 | Hexanol-N II-9.5 EO | 0.80 |
| 27 | Dibutyl phthalate | 1.70 |
| 28 | Benzyl(C₇-C₉-alkyl)phthalate | 3.00 |

1. A composition comprising
(a) a polyvinyl acetate homo- or mixed polymerisate as a polyvinyl acetate plastic and
(b) from 0.01 to 50 weight percent, referring to the total of components (a) and (b), of a mixture of several alkoxylated alcohols according to the formula I
R¹[—O—(R²—O)ₙ—H]ₘ I
with n being different,
where
R¹ is a C₄- to C₁₄-hydrocarbon, optionally a polyvalent one, which optionally can have 1 or 2 free OH groups,
R² is a saturated divalent C₂- to C₄-hydrocarbon which can be different for each n and/or m, and
m is an integer from 1 to 4 and
n is an integer from 4 to 18 which can be different for each m, where in the number average at least 60 percent of the alkoxylated alcohol molecules according to formula I in the composition have for each n of a molecule one n of from +2 to −2 of the number average of n.

2. The composition of claim 1, characterised in that
m is 1 or 2, preferably 1.

3. A composition according to any one of the preceding claims, characterised in that
n is an integer from 4 to 18, preferably 7 to 16, which can be different for each m, where in the number average at least 70 percent of the alkoxylated alcohol molecules according to formula I in the composition have for each n of a molecule one n of from +2 to −2 of the number average of n.

4. The composition of claim 1, characterised in that
R² is —CH₂—CH₂— and/or —CH₂—CH(CH₃)—.

5. A composition according to any one of the preceding claims, characterised in that
R¹ is a saturated C₅- to C₇-hydrocarbon, preferably a linear one.

6. A composition according to any one of the preceding claims, characterised in that the polyvinyl acetate plastic consists of/or comprises at least 50 weight percent, preferably at least 80 weight percent, of monomeric units of the type
—(—CH(—O—CO—CH₃)—CH₂—)—.

7. A composition according to any one of the preceding claims, characterised in that the composition is solid at 25° C. and normal pressure (1013 hPa), i.e. has a pour point of greater than 25° C., preferably greater than 50° C., at normal pressure (1013 hPa).

8. A composition according to any one of the preceding characterised in that the composition does not contain any additional alkoxylated alcohols besides the ones according to formula I.

9. A composition according to any one of the preceding claims, characterised in that the composition does not contain any additional plasticisers besides the alkoxylated alcohols according to formula I.

10. A composition according to any one of the preceding claims, characterised in that
n is an integer from 4 to 18, which can be different for each m, where in the number average at least 70 percent of the alkoxylated alcohol molecules according to formula I in the composition have for each n of a molecule one n of from +2 to −2 of the number average of n and where at least 10 percent have one n of greater than +2 or lower than −2 of the number average of n.
